(19) United States
(12) Patent Application Publication
(10) Pub. No.: US 2024/0402761 A1
(43) Pub. Date: Dec. 5, 2024

(54) PRESSURE-CONTROLLED FACE ENGAGEMENT

(71) Applicant: Apple Inc., Cupertino, CA (US)

(72) Inventors: David D. DOHRENWEND, San Jose, CA (US); Alvin J. HILARIO, Los Altos, CA (US); Ian S. CANIS, San Francisco, CA (US); Lauren C. MONTEMAYOR, Cupertino, CA (US)

(21) Appl. No.: 18/694,376

(22) PCT Filed: Sep. 13, 2022
(86) PCT No.: PCT/US2022/043388

§ 371 Date: Mar. 21, 2024

Related U.S. Application Data
(60) Provisional application No. 63/247,229, filed on Sep. 22, 2021.

(51) Int. Cl. G06F 1/16

(52) U.S. Cl. CPC G06F 1/163

(57) ABSTRACT

A wearable electronic device can include a light seal to comfortably engage the face of the user and to exclude light from an external environment. The light seal can include one or more air bladders that conform as needed to the face of the user. One or more of the air bladders can include a valve that releases air from the air bladder when a pressure within the air bladder exceeds a threshold. Such release can cushion the user from an external force applied to the wearable electronic device. The air bladders can have different configurations, such that greater relief is provided to more sensitive regions of the user's face.

### CROSS-REFERENCE TO RELATED APPLICATION

This application claims the benefit of U.S. Provisional Application No. 63/247,229, entitled “HEAD-MOUNTABLE DEVICE WITH PRESSURE-CONTROLLED FACE ENGAGEMENT,” filed Sep. 22, 2021, the entirety of which is incorporated herein by reference.

### TECHNICAL FIELD

The present description relates generally to head-mountable devices, and, more particularly, to light seals of head-mountable devices having pressure-controlled face engagement.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include speaker output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a top view of a head-mountable device with a light seal, according to some embodiments of the present disclosure.

FIG. 2 illustrates a side view of a head-mountable device with a light seal, according to some embodiments of the present disclosure.

FIG. 3 illustrates a side view of a head-mountable device with a light seal, according to some embodiments of the present disclosure.

FIG. 4 illustrates a front view of a light seal for a head-mountable device, according to some embodiments of the present disclosure.

FIG. 5 illustrates a front view of a light seal for a head-mountable device, according to some embodiments of the present disclosure.

FIG. 6 illustrates a sectional view of a portion of a light seal for a head-mountable device, according to some embodiments of the present disclosure.

FIG. 7 illustrates a sectional view of the portion of the light seal of FIG. 6, according to some embodiments of the present disclosure.

FIG. 8 illustrates a sectional view of the portion of the light seal of FIG. 7, according to some embodiments of the present disclosure.

FIG. 9 illustrates a sectional view of a portion of a light seal for a head-mountable device, according to some embodiments of the present disclosure.

FIG. 10 illustrates a sectional view of the portion of the light seal of FIG. 9, according to some embodiments of the present disclosure.

FIG. 11 illustrates a sectional view of a portion of a light seal for a head-mountable device, according to some embodiments of the present disclosure.

FIG. 12 illustrates a sectional view of the portion of the light seal of FIG. 11, according to some embodiments of the present disclosure.

FIG. 13 illustrates a block diagram of a head-mountable device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mountable displays, headsets, visors, smartglasses, head-up display, etc., can perform a range of functions that are managed by the components (e.g., sensors, circuitry, and other hardware) included with the wearable device.

Given the diversity of users who may wear and operate a head-mountable device, it can be desirable for the head-mountable device to be adaptable to conform to the face of a given one of a variety of users. Additionally, it can be desirable to protect the user from forces applied to portions of the head-mountable device. Such protection can be provided by further allowing adaptations that occur only upon certain conditions arising from impact or other applied forces.

Embodiments of the present disclosure provide a head-mountable device that includes a light seal to comfortably engage the face of the user and to exclude light from an external environment. The light seal can include one or more air bladders that conform as needed to the face of the user. One or more of the air bladders can include a valve that releases air from the air bladder when a pressure within the air bladder exceeds a threshold. Such release can cushion the user from an external force applied to the head-mountable device. The air bladders can have different configurations, such that greater relief is provided to more sensitive regions of the user's face.

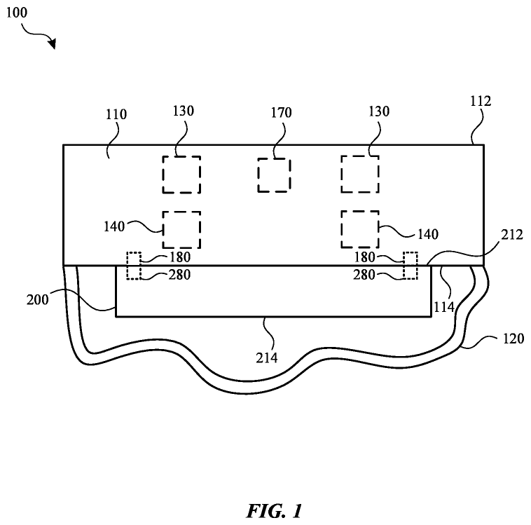

These and other embodiments are discussed below with reference to FIGS. 1-13. However, those skilled in the art will readily appreciate that the detailed description given herein with respect to these Figures is for explanatory purposes only and should not be construed as limiting.

According to some embodiments, for example as shown in FIG. 1, a head-mountable device 100 includes a frame 110 and a light seal 200 that are worn on a head of a user. The frame 110 can be positioned in front of the eyes of a user to provide information within a field of view of the user. The frame 110 and/or the light seal 200 can provide a nosepiece to rest on a user's nose.

The frame 110 can provide structure around a peripheral region thereof to support any internal components of the frame 110 in their assembled position. For example, the frame 110 can enclose and support various internal components (including for example integrated circuit chips, processors, memory devices and other circuitry) to provide computing and functional operations for the head-mountable device 100, as discussed further herein. While several components are shown within the frame 110, it will be understood that some or all of these components can be located anywhere within or on the head-mountable device 100. For example, one or more of these components can be positioned within the light seal 200 and/or a head engager 120 of the head-mountable device 100.

The frame 110 can include and/or support one or more cameras 130. The cameras 130 can be positioned on or near an outer side 112 of the frame 110 to capture images of views external to the head-mountable device 100. As used herein, an outer side of a portion of a head-mountable device is a side that faces away from the user and/or towards an external environment. The captured images can be used for display to the user or stored for any other purpose. Each of the cameras 130 can be movable along the outer side 112. For example, a track or other guide can be provided for facilitating movement of the camera 130 therein.

The head-mountable device 100 can include displays 140 that provide visual output for viewing by a user wearing the head-mountable device 100. One or more displays 140 can be positioned on or near an inner side 114 of the frame 110. As used herein, an inner side 114 of a portion of a head-mountable device is a side that faces toward the user and/or away from the external environment.

A display 140 can transmit light from a physical environment (e.g., as captured by a camera) for viewing by the user. Such a display 140 can include optical properties, such as lenses for vision correction based on incoming light from the physical environment. Additionally or alternatively, a display 140 can provide information as a display within a field of view of the user. Such information can be provided to the exclusion of a view of a physical environment or in addition to (e.g., overlaid with) a physical environment.

A physical environment refers to a physical world that people can interact with and/or sense without necessarily requiring the aid of an electronic device. A computer-generated reality environment relates to a partially or wholly simulated environment that people sense and/or interact with the assistance of an electronic device. Examples of computer-generated reality include, but are not limited to, mixed reality and virtual reality. Examples of mixed realities can include augmented reality and augmented virtuality. Examples of electronic devices that enable a person to sense and/or interact with various computer-generated reality environments include head-mountable devices, projection-based devices, heads-up displays (HUDs), vehicle windshields having integrated display capability, windows having integrated display capability, displays formed as lenses designed to be placed on a person's eyes (e.g., similar to contact lenses), headphones/earphones, speaker arrays, input devices (e.g., wearable or handheld controllers with or without haptic feedback), smartphones, tablets, and desktop/laptop computers. A head-mountable device can have an integrated opaque display, have a transparent or translucent display, or be configured to accept an external opaque display from another device (e.g., smartphone).

Each display 140 can be adjusted to align with a corresponding eye of the user. For example, each display 140 can be moved along one or more axes until a center of each display 140 is aligned with a center of the corresponding eye. Accordingly, the distance between the displays 140 can be set based on an interpupillary distance (“IPD”) of the user. IPD is defined as the distance between the centers of the pupils of a user's eyes.

As further shown in FIG. 1, connectors can facilitate coupling of the frame 110 to the light seal 200 in a relative position and orientation that aligns the displays 140 of the frame 110 in a preferred position and orientation for viewing by the user. The frame 110 and the light seal 200 can be coupled to prevent ingress of light from an external environment. For example, frame connectors 180 can releasably engage light seal connectors 280. One or more of various mechanisms can be provided to secure the modules to each other. For example, mechanisms such as locks, latches, snaps, screws, clasps, threads, magnets, pins, an interference (e.g., friction) fit, knurl presses, bayoneting, and/or combinations thereof can be included to couple and/or secure the frame 110 and the light seal 200 together. The modules can remain secured to each other until an optional release mechanism is actuated. The release mechanism can be provided on an outer surface of the head-mountable device 100 for access by a user.

While the light seal 200 is shown schematically with a particular size and shape, it will be understood that the size and shape of the light seal 200, particularly at the inner side 214 of the light seal 200, can have a size and shape that accommodates the face of a user wearing the head-mountable device 100. For example, the inner side 214 can provide a shape that generally matches the contours of the user's face around the eyes of the user. The inner side 214 can be provided with one or more features that allow the light seal 200 to conform to the face of the user to enhance comfort and block light from entering the light seal 200 at the point of contact with the face. For example, the inner side 214, or portions thereof, can provide a flexible, soft, elastic, and/or compliant structure, as described further herein.

The frame 110 and/or the light seal 200 can be supported on a user's head with a head engager 120. The head engager 120 can wrap or extend along opposing sides of a user's head and/or to a rear of the user's head. The head engager 120 can optionally include earpieces for wrapping around or otherwise engaging or resting on a user's ears. It will be appreciated that other configurations can be applied for securing the head-mountable device 100 to a user's head. For example, one or more bands, straps, belts, caps, hats, or other components can be used in addition to or in place of the illustrated head engager 120 of the head-mountable device 100. The head engager 120 can optionally include a band for extending to and/or about a rear side of the head of the user. The head engager 120 can optionally extend from the frame 110 or another component coupled to the frame 110. For example, the head engager 120 can optionally extend from the light seal 200. The band can be stretchable to comfortably provide tension about the head of the user. The head engager can further include an adjuster (not shown) for adjusting a tightness and/or fit of the head engager.

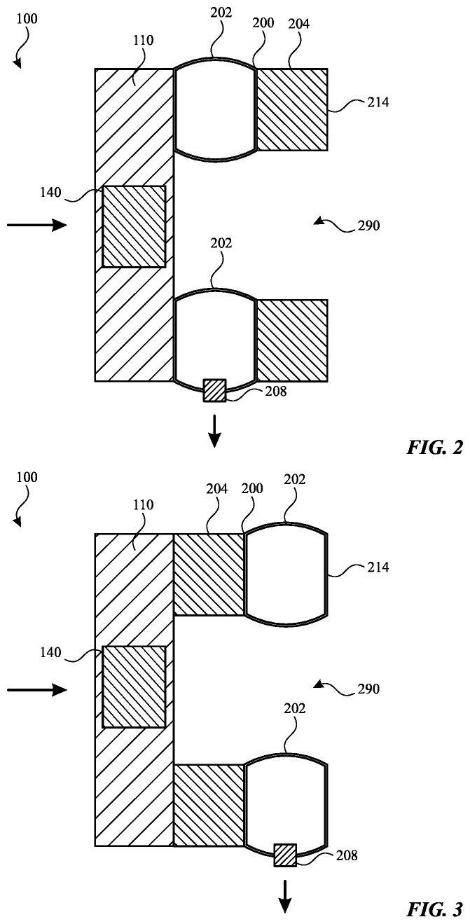

Referring now to FIGS. 2 and 3, a light seal can be selected with various portions that match the contours of the face of the user. The light seal 200 can include one or more bladders that are adaptable to conform to the face of the user and/or respond to impact events by relieving pressure therein.

As shown in FIG. 2, the light seal 200 can include one or more air bladders 202 between the frame 110 and an inner side 214 of the light seal 200. The one or more air bladders 202 can be positioned on opposing sides of a channel 290, wherein the channel 290 can provide a user with a view to the display 140. For example, portions of a single air bladder 202 and/or different air bladders 202 can be positioned on opposing sides of the channel 290.

The light seal 200 can further include a cushion 204 defining the inner side 214 of the light seal 200. For example, the cushion 204 can provide a surface for directly engaging the face of the user while the head-mountable device 100 is worn by the user. The cushion 204 can provide features for an adaptable fit that are optionally independent of the features of the one or more air bladders 202. For example, the cushion 204 can include a compressible and/or flexible material, such as foam, elastic, and the like. The cushion 204 can further provide features for comfortably contacting the face of the user. For example, the cushion 204 can include or accompany a breathable and/or stretchable material, such as fabric, textiles, mesh, and the like.

A head engager can gently pull the light seal 200 against the face of the user to urge the air bladder 202 to conform with the facial regions of the user. As the light seal is pulled toward and against the face of the user, the corresponding bladders can deform as they engage the facial features. As such, the forces against the face can be distributed widely across the engagement surfaces at the inner side 214 to enhance comfort of the user. Such compliance can enhance comfort of the user.

The one or more air bladders 202 can further adapt in response to greater forces when applied to the head-mountable device. As shown in FIG. 2, the one or more air bladders 202 can include one or more valves 208 for allowing air and/or another fluid to exit and/or enter the one or more air bladders 202. For example, upon occurrence of an impact event or other applied force to the head-mountable device (e.g., the frame 110), it can be desirable to absorb some or all of the applied forces, so that the forces are not transmitted to the user. In some embodiments, the valve 208 can allow air and/or another fluid to exit the one or more air bladders 202 in response to an applied force. Such deflation of the one or more air bladders 202 can absorb the applied forces and/or extend the duration of time (e.g., increase impulse) across which the forces are transmitted to the face of the user.

The one or more valves 208 of the light seal 200 can be configured to respond to pressure conditions in the corresponding one or more air bladders 202. For example, a valve 208 can be a pressure relief valve that operates at a threshold pressure to allow air and/or other fluids to pass there through. Under other pressure conditions, the valve 208 can prevent air and/or other fluids to pass there through. Pressure conditions can refer to conditions within and/or outside the corresponding air bladder 202. For example, pressure conditions can be determined based on the pressure within an air bladder 202 relative to the pressure on an opposing side of the valve 208 (e.g., the pressure in an external environment of the head-mountable device 100 or atmospheric pressure). By further example, the valve 208 can be a relief valve, a safety valve, a safety relief valve, and/or a pressure safety valve.

The valve 208 can be configured to respond to a particular pressure condition. For example, the valve 208 can be selected to respond to pressures above a threshold by opening and/or otherwise allowing air and/or another fluid within the air bladder 202 to exit through the valve 208. By further example, the valve 208 can be selected to respond to pressures below a threshold (e.g., the same or a different threshold as described above) by opening and/or otherwise allowing air and/or another fluid outside of the air bladder 202 to enter through the valve 208.

It will be understood that operation of the valve 208 can be automated, such that no external input, signal, and/or control is required to allow the valve 208 to respond to pressure conditions and/or applied forces. Additionally or alternatively, the valve 208 can be actively controlled, for example by the head-mountable device 100 and/or by a user.

It will be understood that the light seal 200, by virtue of the one or more air bladders 202 and/or the cushion 204, can conform to a user's face without requiring air and/or another fluid to pass through the valve 208. As such, the user can wear the head-mountable device 100 and maintain the frame 110 in a consistent position and/or orientation with respect to the face of the user, particularly in the absence of an impact event that applies a force to the head-mountable device 100. In contrast, upon occurrence of an impact event or other applied force to the head-mountable device (e.g., the frame 110), the one or more air bladders 202 can change their shape to absorb some or all of the applied forces, so that the forces are not transmitted to the user.

As shown in FIG. 3, the light seal 200 can include one or more air bladders 202 defining the inner side 214 of the light seal 200. For example, the one or more air bladders 202 can provide a surface for directly engaging the face of the user while the head-mountable device 100 is worn by the user. The one or more air bladders 202 can further provide features for comfortably contacting the face of the user. For example, the cushion 204 can include or accompany a breathable and/or stretchable material, such as fabric, textiles, mesh, and the like. The light seal 200 can have one or more of the features described herein with respect to the light seal 200 of FIG. 2.

The light seal 200 can further include a cushion 204 between the frame 110 and one or more air bladders 202. The cushion 204 can have one or more of the features described herein with respect to the cushion 204 of FIG. 2.

It will be understood that the cushion 204 is optional and, in some embodiments, the one or more air bladders 202 can be provided without a cushion 204. In some embodiments, multiple cushions 204 can be provided, for example on opposing sides of one or more air bladders 202. In some embodiments, multiple layers of air bladders 202 can be provided.

Referring now to FIG. 4, multiple distinct air bladders can be provided to engage different parts of a user's face. The face of the user can be engaged at multiple regions thereof. However, some regions of the face are more sensitive (e.g., to pressure) than others. Some regions of the face have more rigid structural (e.g., bone) support, such as at the forehead, while other have more soft tissue, such as at the cheeks. Given these differences, it can be desirable to provide air bladders that have different operating conditions so that they respond differently to the same impact event in a manner that is appropriate for its region of facial engagement.

For example, as shown in FIG. 4, the light seal 200 can include an upper bladder 220 for engaging the forehead of the user and lower bladders 240 for engaging the cheeks of the user. By further example, the light seal 200 can include side bladders 250 for engaging sides of the user's face (e.g., along the temples of the user's head). The upper bladder 220, the lower bladders 240, and/or the side bladders 250 can correspond to and/or have one or more of the features of the air bladders 202 of FIGS. 2 and 3.

Any number of other bladders can be provided, including sub-divisions of the bladders described herein. While five separate bladders are shown in FIG. 4, it will be understood that any number of discrete bladders can be provided. For example, the number of bladders defining the inner side or another portion of the light seal 200 can be 1, 2, 3, 4, 5, 6, 7, 8, 9, 10, or more than 10. In some embodiments, the bladder(s) can, together, define a continuous surface (e.g., on the inner side 214) for engaging the face of the user.

In some embodiments, the light seal 200 can further include a nosepiece 260 for engaging a nose of the user. Alternatively, the nosepiece 260 can be a component of the frame (not shown), and the light seal 200 can accommodate the nosepiece 260. The nosepiece 260 can be positioned between, for example, lower bladders 240 of the light seal 200. In some embodiments, the nosepiece 260 need not include an air bladder. In some embodiments, the nosepiece 260 includes an air bladder with a corresponding valve (not shown).

The bladders of the light seal 200 can at least partially surround the channel 290, which provides a user with a view to the displays (not shown). For example, separate bladders or portions of the same bladder can extend about the channel to opposing sides thereof. As shown in FIG. 4, the side bladders 250 can be on opposing sides of the channel 290. As further shown in FIG. 4, the upper bladder 220 can be on a side of the channel 290 that is opposite one or both of the lower bladders 240. It will be understood that the air bladders need not be contiguous to at least partially surround the channel 290. It will be further understood that the air bladders need not extend about an entirety of the channel. For example, as shown in FIG. 4, the bladders can surround the channel 290 and leave a gap for the nosepiece 260.

The bladders can have different features to provide different performance upon occurrence of an impact event. For example, one or more of the bladders can include a valve, and one or more of the bladders can omit a valve (e.g., be fully sealed). As shown in FIG. 4, the lower bladders 240 can each include a lower valve 242 for allowing passage of air and/or another fluid therethrough. The upper bladder 220 can optionally omit a valve and/or otherwise be fully sealed. By omitting a valve from the upper bladder 220, the upper bladder 220 can be more resilient, and the lower bladders 240 can be more responsive to applied forces by releasing air and/or other fluids through the lower valves 242. Accordingly, upon an impact event, the lower bladders 240 can provide a greater amount of relief at the cheeks of the user than will be provided by the upper bladder 220 at the forehead of the user.

As further shown in FIG. 4, the side bladders 250 can each include a side valve 252 for allowing passage of air and/or another fluid therethrough. The side bladders 250 can be more responsive to applied forces (e.g., compared to the upper bladder 220) by releasing air and/or other fluids through the side valves 252. Accordingly, upon an impact event, the side bladders 250 can provide a greater amount of relief at the sides of the user's head then will be provided by the upper bladder 220 at the forehead of the user.

In some embodiments, different valves can have different thresholds for activation, such that different types of relief are provided by the corresponding bladders. For example, where a lower bladder 240 includes a lower valve 242 and a side bladder 250 includes a side valve 252, the lower valve 242 can have a threshold for activation that is lower than a threshold for activation of the side valve 252. With such a configuration, the lower bladder 240 can provide relief more readily than the side bladder 250 so that forces are distributed away from the cheeks of the user. It will be understood that other arrangements are also contemplated. In some embodiments, the lower valve 242 can have a threshold for activation that is higher than a threshold for activation of the side valve 252. In some embodiments, where an upper bladder 220 includes an upper valve (not shown), a lower valve 242 and/or a side valve 252 can have a threshold for activation that is lower than a threshold for activation of the upper valve. With such a configuration, forces may be distributed away from the cheeks and/or sides of the user's head and focused on the forehead. In some embodiments, the lower valve 242 and/or the side valve 252 can have a threshold for activation that is higher than a threshold for activation of the upper valve.

As shown in FIG. 4, each of the upper bladder 220, the lower bladders 240, and the side bladders 250 can be fluidly isolated from each other, such that no two of the upper bladder 220, the side bladders 250, and the lower bladders 240 are in fluid communication with each other, even wherein one, some, or all of the bladders include a corresponding valve. While each of the bladders can be fluidly isolated from each other, one, some, or all of the bladders can include valves to selectively place each of the bladders in fluid communication with an external environment, as described herein.

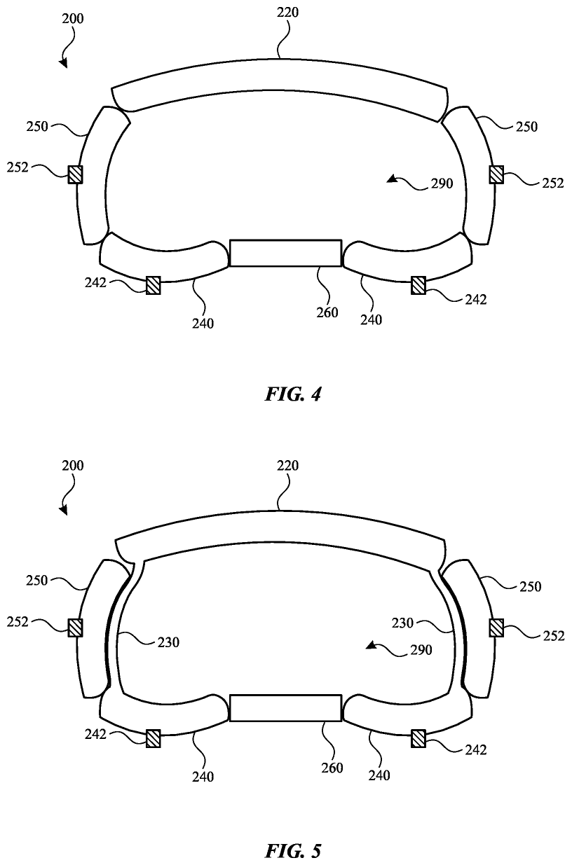

Referring now to FIG. 5, multiple distinct air bladders can be in fluid communication with each other. The interconnected bladders can provide their own valves or rely on the valves of another interconnected bladder for passage of air and/or another fluid.

As shown in FIG. 5, one or more of the bladders, such as an upper bladder 220, can be in fluid communication with another one or more of the bladders, such as the lower bladders 240. The upper bladder 220 can be fluidly connected to the lower bladders 240 by corresponding conduits 230. The conduits 230 can provide a relatively narrow passage between a pair of the bladders. For example, a width of the conduit 230 can be narrower than a width of either of the upper bladder 220 or the lower bladders 240. By providing a relatively narrow conduit 230 air and/or other fluids can pass slowly and/or gradually through the conduits to equalize pressure between the connected pair of bladders. As such, relief to one bladder, such as the upper bladder 220, can be received through the conduit 230 and the other bladder, such as the lower bladder 240, albeit at a controlled rate. Other features of the conduits can limit flow therethrough. For example, the conduits can include flow restrictors, valves, torturous pathways, and/or obstructions to limit flow therethrough.

In some embodiments, at least one of the bladders can lack a valve or otherwise rely on the conduit and the interconnected bladder to receive relief under certain pressure conditions. For example, as shown in FIG. 5, the upper bladder 220 can lack a valve. As such, the upper bladder 220 can receive relief from pressure conditions only through one or more conduits 230 and/or the lower bladders 240 connected thereby. The lower bladders 240 can each include a lower valve 242, such that the lower bladders 240 can provide relief in the event of high-pressure conditions, as described herein. Additionally, the upper bladder 220 can receive relief from high-pressure conditions only by moving its air and/or other fluid through the conduits 230 to the lower bladders 240 and through the corresponding lower valves 242. Accordingly, the relief provided to the upper bladder 220 can be more gradual and/or otherwise delayed relative to the relief provided directly to the lower bladders 240 by the lower valves 242. Accordingly, upon an impact event, the lower bladders 240 can provide a greater amount of relief at the cheeks of the user than will be provided by the upper bladder 220 at the forehead of the user.

While the embodiment of FIG. 5 shows an upper bladder 220 in fluid communication with lower bladders 240, it will be understood that any one bladder of the light seal 200 can be in fluid communication with one or more other bladders by a corresponding conduit placing both in fluid communication with each other. For example, the upper bladder 220 can be in fluid communication with one or more of the side bladders 250 via a corresponding conduit. By further example, one or more of the side bladders 250 can be in fluid communication with one or more of the lower bladders 240 via a corresponding conduit.

In some embodiments, one or more of the bladders can be isolated from other bladders of the light seal 200. For example, as further shown in FIG. 5, the side bladders 250 can provide side valves 252 without being connected to any other bladder of the light seal 200. The side bladders 250 can be positioned alongside the conduits and/or between the upper bladder 220 and a corresponding one of the lower bladders 240.

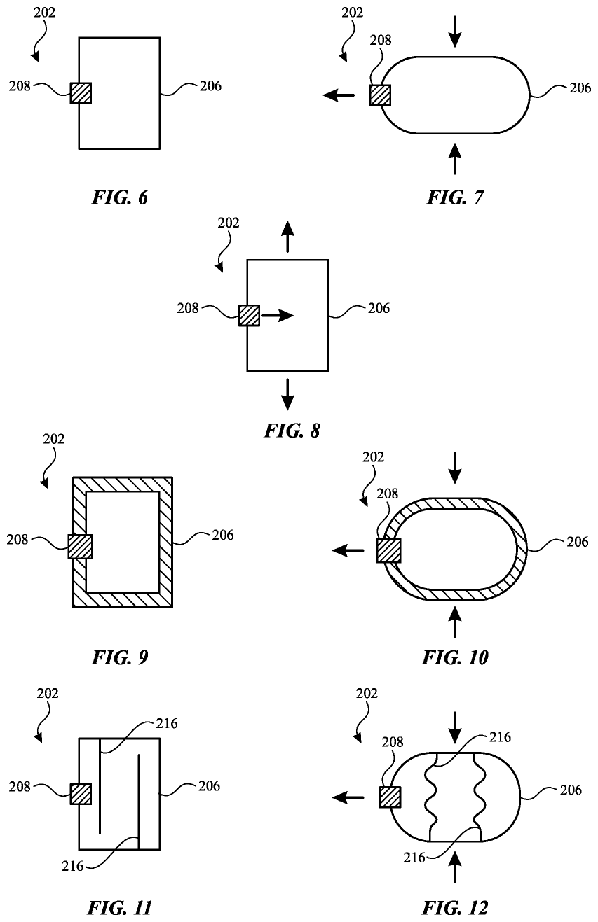

Referring now to FIGS. 6-12, the bladders of a light seal can be provided with various features that control their responsiveness to pressure conditions upon occurrence of an impact event and/or other applied forces to a head-mountable device. Such features can allow the corresponding bladders to respond differently so that forces are mitigated and/or distributed as desired with respect to the face of the user.

As shown in FIG. 6, an air bladder 202 can include an outer wall 206 defining an interior chamber. A valve 208 of the air bladder 202 can provide selective fluid communication between the interior chamber and an external environment. The outer wall 206 can have intrinsic resilience, such that, while being somewhat compliant to change its shape upon application external force, the outer wall 206 can be biased to return to its initial shape upon removal of the external force. The air bladder 202 can be elastic to provide adequate compliance while also allowing the air bladder 202 to return to its initial shape.

For example, as shown in FIG. 7, when external forces are applied to the air bladder 202, such as when an external force is applied to the frame of the head-mountable device in a direction of the face of the user, the air bladder 202 can compliantly deform to be compressed along at the direction of the applied force and/or expanded along a direction that is her saga and all to the direction of the applied force. Such deformation can be provided regardless of whether the valve 208 becomes active. Where the pressure within the air bladder 202 exceeds a threshold, the valve 208 can be activated to release air and/or other fluids therethrough to an external environment.

As shown in FIG. 8, when the external force has been removed, the air bladder 202 can return to its initial shape, for example by virtue of an intrinsic resilience provided by the outer wall 206. The valve 208 can further be activated to receive air and/or other fluids from the external environment to be drawn into the inner chamber of the air bladder 202. While the resilience to return to initial shape can be provided by the outer walls 206 of the air bladder 202, it will be understood that other features can be provided to bias the air bladder 202 to an initial shape. For example, the inner chamber of the air bladder 202 can include an elastic fill material, foam, springs, and/or other media that provides radially outwardly directed forces to the outer walls 206 of the air bladder 202.

As shown in FIGS. 9-10, an air bladder 202 can be provided with different features to provide different performance characteristics. For example, the outer walls 206 of an air bladder 202 can have a thickness that provides enhanced the resilience. Where the thickness of the outer walls 206 is greater, the air bladder 202 can provide less compliance and a more rapid return to an initial shape. For example, lower bladders can have walls that are thinner, and an upper bladder can have walls that are thicker than the walls of the lower bladders. By providing the upper bladder with thicker walls, the upper bladder can be more resilient, and the lower bladders can be more responsive to applied forces. Accordingly, upon an impact event, the lower bladders can provide a greater amount of relief at the cheeks of the user than will be provided by the upper bladder at the forehead of the user.

Additionally or alternatively, lower bladders can have walls that are thicker than the walls of the upper bladder. Additionally or alternatively, side bladders can have walls that are thicker or thinner than the walls of the lower bladders and/or the upper bladder. Additionally or alternatively, the material of a bladder can be different than the material of another bladder. For example, the material of one bladder can have a different modulus of elasticity than the other bladder.

As shown in FIGS. 11-12, an air bladder 202 can include other features to provide particular performance characteristics. For example, an air bladder 202 can include inner walls 216 that extend into an inner chamber are defined by the outer walls 206. The inner walls 216 can limit and/or direct flow of air and/or another fluid through the air bladder 202. By further example, as shown in FIG. 11, the inner walls 216 can form a tortuous pathway for passage of air to and/or from the valve 208. With such a pathway, the time required to move air and/or another fluid through the air bladder 202 can be extended.

As shown in FIG. 12, the inner walls 216 of the air bladder 202 can interact with the outer walls 206 upon deformation of the air bladder 202. Such an interaction can further limit flow through the chamber, for example by narrowing the passageways. The inner walls 216 can further provide additional resilience to the air bladder 202. For example, as the air bladder 202 deforms, the inner walls 216 can be compressed or otherwise deformed from a preferred and/or relaxed configuration. Where the inner walls 216 have an intrinsic resilience to return to an initial shape, the inner walls 216 can push off of the outer walls 206 or otherwise urge the air bladder 202 to return to its own initial shape.

Other features of the air bladder 202 can limit flow therethrough and/or enhance compliance and/or resilience. For example, the air bladder 202 can include flow restrictors, valves, torturous pathways, and/or obstructions to limit flow therethrough. Or alternatively, the inner chamber of the air bladder 202 can include an elastic fill material, foam, springs, and/or other media that provides radially outwardly directed forces to the outer walls 206 of the air bladder 202.

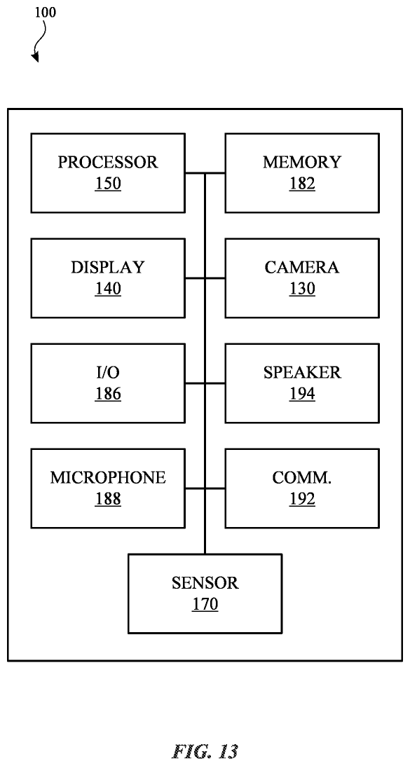

Referring now to FIG. 13, components of the head-mountable device can be operably connected to provide the performance described herein. FIG. 13 shows a simplified block diagram of an illustrative head-mountable device 100 in accordance with one embodiment of the invention. It will be appreciated that components described herein can be provided on one, some, or all of a frame, a light seal, and/or a head engager. It will be understood that additional components, different components, or fewer components than those illustrated may be utilized within the scope of the subject disclosure.

As shown in FIG. 13, the head-mountable device 100 can include a processor 150 (e.g., control circuity) with one or more processing units that include or are configured to access a memory 182 having instructions stored thereon. The instructions or computer programs may be configured to perform one or more of the operations or functions described with respect to the head-mountable device 100. The processor 150 can be implemented as any electronic device capable of processing, receiving, or transmitting data or instructions. For example, the processor 150 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The memory 182 can store electronic data that can be used by the head-mountable device 100. For example, the memory 182 can store electrical data or content such as, for example, audio and video files, documents and applications, device settings and user preferences, timing and control signals or data for the various modules, data structures or databases, and so on. The memory 182 can be configured as any type of memory. By way of example only, the memory 182 can be implemented as random access memory, read-only memory, Flash memory, removable memory, or other types of storage elements, or combinations of such devices.

The head-mountable device 100 can further include a display 140 for displaying visual information for a user. The display 140 can provide visual (e.g., image or video) output. The display 140 can be or include an opaque, transparent, and/or translucent display. The display 140 may have a transparent or translucent medium through which light representative of images is directed to a user's eyes. The display 140 may utilize digital light projection, OLEDs, LEDS, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. The head-mountable device 100 can include an optical subassembly configured to help optically adjust and correctly project the image-based content being displayed by the display 140 for close up viewing. The optical subassembly can include one or more lenses, mirrors, or other optical devices.

The head-mountable device 100 can include one or more sensors 170, as described herein. The head-mountable device 100 can include one or more other sensors. Such sensors can be configured to sense substantially any type of characteristic such as, but not limited to, images, pressure, light, touch, force, temperature, position, motion, and so on. For example, the sensor can be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. By further example, the sensor can be a bio-sensor for tracking biometric characteristics, such as health and activity metrics. Other user sensors can perform facial feature detection, facial movement detection, facial recognition, eye tracking, user mood detection, user emotion detection, voice detection, etc. Sensors can include a camera which can capture image based content of the outside world.

The head-mountable device 100 can include an input/output component 186, which can include any suitable component for connecting head-mountable device 100 to other devices. Suitable components can include, for example, audio/video jacks, data connectors, or any additional or alternative input/output components. The input/output component 186 can include buttons, keys, or another feature that can act as a keyboard for operation by the user.

The head-mountable device 100 can include the microphone 188 as described herein. The microphone 188 can be operably connected to the processor 150 for detection of sound levels and communication of detections for further processing, as described further herein.

The head-mountable device 100 can include one or more speakers 194. The speakers 194 can be operably connected to the processor 150 for control of audio output, including sound levels, as described further herein.

The head-mountable device 100 can include communications circuitry 192 for communicating with one or more servers or other devices using any suitable communications protocol. For example, communications circuitry 192 can support Wi-Fi (e.g., a 802.11 protocol), Ethernet, Bluetooth, high frequency systems (e.g., 900 MHZ, 2.4 GHZ, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. Communications circuitry 192 can also include an antenna for transmitting and receiving electromagnetic signals.

The head-mountable device 100 can include a battery, which can charge and/or power components of the head-mountable device 100. The battery can also charge and/or power components connected to the head-mountable device 100.

Accordingly, embodiments of the present disclosure provide a head-mountable device that can include a light seal to comfortably engage the face of the user and to exclude light from an external environment. The light seal can include one or more air bladders that conform as needed to the face of the user. One or more of the air bladders can include a valve that releases air from the air bladder when a pressure within the air bladder exceeds a threshold. Such release can cushion the user from an external force applied to the head-mountable device. The air bladders can have different configurations, such that greater relief is provided to more sensitive regions of the user's face.

Various examples of aspects of the disclosure are described below as clauses for convenience. These are provided as examples, and do not limit the subject technology.

Clause A: a head-mountable device comprising: a frame supporting a camera and a display; and a light seal coupled to the frame, the light seal comprising: one or more air bladders at least partially surrounding a channel for viewing the display; and a valve configured to release air from the air bladder when a pressure within the air bladder exceeds a threshold.

Clause B: a head-mountable device comprising: a frame supporting a camera and a display; and a light seal comprising: a first air bladder; a first valve configured to release air from the first air bladder when a pressure within the first air bladder exceeds a first threshold; a second air bladder; and a second valve configured to release air from the second air bladder when a pressure within the second air bladder exceeds a second threshold, different than the first threshold.

Clause C: a head-mountable device comprising: a frame supporting a camera and a display; and a light seal comprising: a first air bladder; a second air bladder in fluid communication with the first air bladder via a conduit for exchanging air between the first air bladder and the second air bladder; and a valve at the second air bladder and configured to release air from the first air bladder via the second air bladder.

One or more of the above clauses can include one or more of the features described below. It is noted that any of the following clauses may be combined in any combination with each other, and placed into a respective independent clause, e.g., clause A, B, or C.

Clause 1: the one or more air bladders comprises: an upper bladder for engaging a forehead of a user; side bladders for engaging sides of a head of the user; and lower bladders for engaging cheeks of the user.

Clause 2: the valve is positioned at one of the side bladders; and the light seal further comprises additional valves at another of the side bladders and at each of the lower bladders.

Clause 3: no two of the upper bladder, the side bladders, and the lower bladders are in fluid communication with each other.

Clause 4: a nosepiece between the lower bladders.

Clause 5: the one or more air bladders has an outer wall and inner walls that extend from the outer walls to an interior of the one or more air bladders.

Clause 6: the light seal further comprises a foam cushion between the frame and the one or more air bladders.

Clause 7: the light seal further comprises a foam cushion, the one or more air bladders being positioned between the frame and the foam cushion.

Clause 8: the first air bladder is an upper bladder positioned to engage a forehead of a user while the head-mountable device is worn by the user; and the second air bladder is a lower bladder positioned to engage a cheek of the user while the head-mountable device is worn by the user.

Clause 9: the first threshold is greater than the second threshold.

Clause 10: the first air bladder has a wall thickness that is greater than a wall thickness of the second air bladder.

Clause 11: the first air bladder has an outer wall and inner walls that extend from the outer walls to an interior of the first air bladder.

Clause 12: the light seal further comprises a side bladder for engaging sides of a head of the user, wherein the side bladder is positioned between the upper bladder and the lower bladder.

Clause 13: the light seal further comprises: a third air bladder positioned to engage another cheek of a user while the head-mountable device is worn by the user, the third air bladder being in fluid communication with the first air bladder via another conduit for exchanging air between the first air bladder and the third air bladder; and an additional valve at the third air bladder and configured to release additional air from the first air bladder via the third air bladder.

Clause 14: the conduit has a width that is smaller than a width of the first air bladder and a width of the second air bladder.

As described herein, aspects of the present technology can include the gathering and use of data. The present disclosure contemplates that in some instances, gathered data can include personal information or other data that uniquely identifies or can be used to locate or contact a specific person. The present disclosure contemplates that the entities responsible for the collection, analysis, disclosure, transfer, storage, or other use of such personal information or other data will comply with well-established privacy practices and/or privacy policies. The present disclosure also contemplates embodiments in which users can selectively block the use of or access to personal information or other data (e.g., managed to minimize risks of unintentional or unauthorized access or use).

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A head-mountable device comprising:
a frame supporting a camera and a display; and
a light seal coupled to the frame, the light seal comprising:
an air bladder at least partially surrounding a channel for viewing the display; and
a valve configured to release air from the air bladder when a pressure within the air bladder exceeds a threshold.

2. The head-mountable device of claim 1, wherein the air bladder is one of multiple air bladders comprising:
an upper bladder for engaging a forehead;
side bladders for engaging sides of a head; and
lower bladders for engaging cheeks.

3. The head-mountable device of claim 2, wherein:
the valve is positioned at one of the side bladders; and
the light seal further comprises additional valves at another of the side bladders and at each of the lower bladders.

4. The head-mountable device of claim 2, wherein no two of the upper bladder, the side bladders, and the lower bladders are in fluid communication with each other.

5. The head-mountable device of claim 2, further comprising a nosepiece between the lower bladders.

6. The head-mountable device of claim 1, wherein the air bladder has an outer wall and inner walls that extend from the outer walls to an interior of the air bladder.

7. The head-mountable device of claim 1, wherein the light seal further comprises a foam cushion between the frame and the air bladder.

8. The head-mountable device of claim 1, wherein the light seal further comprises a foam cushion, the air bladder being positioned between the frame and the foam cushion.

9. A head-mountable device comprising:
a frame supporting a camera and a display; and
a light seal comprising:
a first air bladder;
a first valve configured to release air from the first air bladder when a pressure within the first air bladder exceeds a first threshold;
a second air bladder; and
a second valve configured to release air from the second air bladder when a pressure within the second air bladder exceeds a second threshold, different than the first threshold.

10. The head-mountable device of claim 9, wherein:
the first air bladder is an upper bladder positioned to engage a forehead while the head-mountable device is worn; and
the second air bladder is a lower bladder positioned to engage a cheek while the head-mountable device is worn.

11. The head-mountable device of claim 10, wherein the first threshold is greater than the second threshold.

12. The head-mountable device of claim 9, wherein the first air bladder has a wall thickness that is greater than a wall thickness of the second air bladder.

13. The head-mountable device of claim 9, wherein the first air bladder has an outer wall and inner walls that extend from the outer walls to an interior of the first air bladder.

14. A head-mountable device comprising:
a frame supporting a camera and a display; and
a light seal comprising:
a first air bladder;
a second air bladder in fluid communication with the first air bladder via a conduit for exchanging air between the first air bladder and the second air bladder; and
a valve at the second air bladder and configured to release air from at least one of the first air bladder or the second air bladder.

15. The head-mountable device of claim 14, wherein:
the first air bladder is an upper bladder positioned to engage a forehead while the head-mountable device is worn; and
the second air bladder is a lower bladder positioned to engage a cheek while the head-mountable device is worn.

16. The head-mountable device of claim 15, wherein the light seal further comprises a side bladder for engaging sides of a head, wherein the side bladder is positioned between the upper bladder and the lower bladder.

17. The head-mountable device of claim 15, wherein the light seal further comprises:
a third air bladder positioned to engage another cheek while the head-mountable device is worn, the third air bladder being in fluid communication with the first air bladder via another conduit for exchanging air between the first air bladder and the third air bladder; and
an additional valve at the third air bladder and configured to release additional air from at least one of the first air bladder or the third air bladder.

18. The head-mountable device of claim 14, wherein the conduit has a width that is smaller than a width of the first air bladder and a width of the second air bladder.

19. The head-mountable device of claim 14, wherein the first air bladder has a wall thickness that is greater than a wall thickness of the second air bladder.

20. The head-mountable device of claim 14, wherein the first air bladder has an outer wall and inner walls that extend from the outer walls within an interior of the first air bladder.
